(19) United States
(12) Patent Application Publication
(10) Pub. No.: US 2014/0074729 A1
(43) Pub. Date: Mar. 13, 2014

(54) REPORT CREATION DEVICE, REPORT CREATION SYSTEM, AND COMPUTER-READABLE STORAGE MEDIUM

(71) Applicant: Kenji KAWASUMI, Kanagawa (JP)

(72) Inventor: Kenji KAWASUMI, Kanagawa (JP)

(21) Appl. No.: 14/013,178

(22) Filed: Aug. 29, 2013

(30) Foreign Application Priority Data
Sep. 10, 2012 (JP) 2012-198895
Jun. 26, 2013 (JP) 2013-133974

(51) Int. Cl. G06Q 30/00

(52) U.S. Cl. CPC G06Q 30/016
USPC 705/304

(57) ABSTRACT

A report creation device includes a device information acquisition unit configured to acquire device information about a device; a failure information acquisition unit configured to acquire failure information about failure that occurs in the device; a person information acquisition unit configured to acquire person information about a person who handles the failure that occurs in the device, the person information indicating at least a contact number of the person; a creation unit configured to create a report based on the device information, the failure information, and the person information; and an output unit configured to output the report.

### CROSS-REFERENCE TO RELATED APPLICATIONS

The present application claims priority to and incorporates by reference the entire contents of Japanese Patent Application No. 2012-198895 filed in Japan on Sep. 10, 2012 and Japanese Patent Application No. 2013-133974 filed in Japan on Jun. 26, 2013.

### BACKGROUND OF THE INVENTION

1. Field of the Invention

The present invention relates to a report creation device, a report creation system, and a computer-readable storage medium.

2. Description of the Related Art

Conventionally, in a field of MDS (Managed Document Service), a technique of managing management device operation statuses such as an operation rate, the number of failures and failure details of devices in customer environment, and providing the device operation statuses as service reports to customers is known (see, for example, Japanese Laid-open Patent Publication No. 2011-100283).

However, according to the above conventional technique, content of a report is mainly an objective operation status of a device. Therefore, even when a report is analyzed and a problem is found, it is not possible to learn a cause of this problem from the report and it is difficult to immediately take an action to solve the problem.

Therefore, there is a need to provide a report creation device, a report creation system, and a computer-readable storage medium which can create a report which enables a user to take an action of solving a problem.

### SUMMARY OF THE INVENTION

It is an object of the present invention to at least partially solve the problems in the conventional technology.

According to an embodiment, there is provided a report creation device that includes a device information acquisition unit configured to acquire device information about a device; a failure information acquisition unit configured to acquire failure information about failure that occurs in the device; a person information acquisition unit configured to acquire person information about a person who handles the failure that occurs in the device, the person information indicating at least a contact number of the person; a creation unit configured to create a report based on the device information, the failure information, and the person information; and an output unit configured to output the report.

According to another embodiment, there is provided a report creation system that includes a device management unit configured to manage device information about a device; a failure management unit configured to manage failure information about failure that occurs in the device; a person management unit configured to manage person information about a person who handles the failure that occurs in the device, and which indicates at least a contact number of the person; a creation unit configured to create a report based on the device information, the failure information, and the person information; and an output unit configured to output the report.

According to still another embodiment, there is provided a non-transitory computer-readable storage medium with an executable program stored thereon and executed by a computer. The program instructs the computer to perform: acquiring device information about a device; acquiring failure information about failure that occurs in the device; acquiring person information about a person who handles the failure that occurs in the device, the person information indicating at least a contact number of the person; creating a report based on the device information, the failure information, and the person information; and outputting the report.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating an example of a configuration of a report creation system according to the present embodiment;

FIG. 2 is a block diagram illustrating an example of a configuration of a customer management device according to the present embodiment;

FIG. 3 is a view illustrating an example of customer information according to the present embodiment;

FIG. 4 is a block diagram illustrating an example of a configuration of a group management device according to the present embodiment;

FIG. 5 is a view illustrating an example of group information according to the present embodiment;

FIG. 6 is a block diagram illustrating an example of a configuration of a device management device according to the present embodiment;

FIG. 7 is a view illustrating an example of device information according to the present embodiment;

FIG. 8 is a block diagram illustrating an example of a configuration of a failure management device according to the present embodiment;

FIG. 9 is a view illustrating an example of failure information according to the present embodiment;

FIG. 10 is a block diagram illustrating an example of a configuration of a serviceman management device according to the present embodiment;

FIG. 11 is a view illustrating an example of serviceman information according to the present embodiment;

FIG. 12 is a block diagram illustrating an example of a configuration of a report creation device according to the present embodiment;

FIG. 13 is a view illustrating an example of a hierarchical structure of customer information, group information, device information, failure information and serviceman information according to the present embodiment;

FIG. 14 is a view illustrating an example of a group report in continent units according to the present embodiment;

FIG. 15 is a view illustrating an example of a group report in country units according to the present embodiment;

FIG. 16 is a view illustrating an example of a group report in city units according to the present embodiment;

FIG. 17 is a view illustrating an example of a device report according to the present embodiment;

FIG. 18 is a view illustrating an example of a failure report according to the present embodiment;

FIG. 19 is a view illustrating an example of contact number information according to the present embodiment;

FIG. 20 is a flowchart illustrating an example of report creation processing executed by the report creation system according to the present embodiment;

FIG. 21 is a flowchart illustrating an example of processing executed by a creation unit according to the present embodiment;

FIG. 22 is a block diagram illustrating an example of a configuration of a report creation system according to Modification 1;

FIG. 23 is a block diagram illustrating an example of a configuration of a failure management device according to Modification 1;

FIG. 24 is a view illustrating an example of contact number information according to Modification 2;

FIG. 25 is a view illustrating an example of a failure report according to Modification 2; and

FIG. 26 is a block diagram illustrating an example of a hardware configuration of each device according to the present embodiment and each modification.

### DETAILED DESCRIPTION OF THE PREFERRED EMBODIMENTS

Hereinafter, an embodiment of a report creation device, a report creation system and a program according to the present invention will be described in detail with reference to the accompanying drawings.

First, a configuration of a report creation system which includes a report creation device according to the present embodiment will be described.

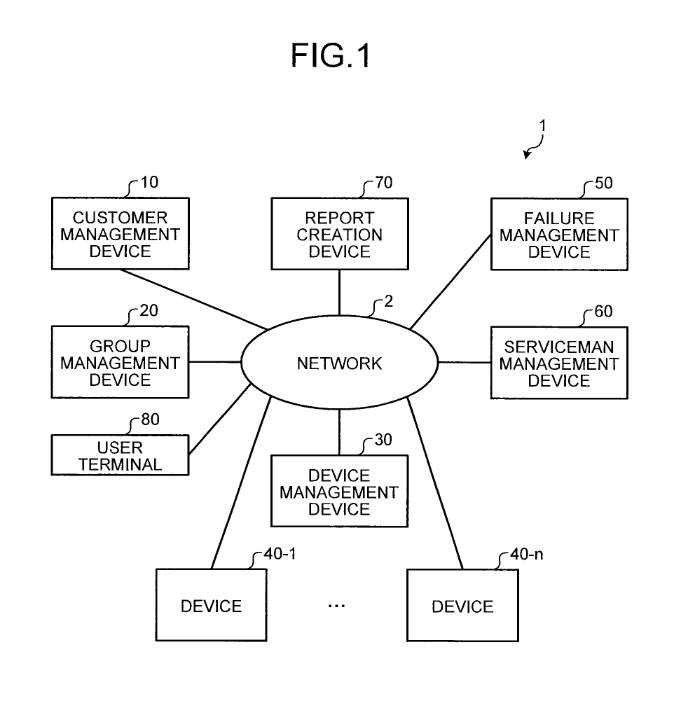

FIG. 1 is a block diagram illustrating an example of a configuration of a report creation system 1 according to the present embodiment. As illustrated in FIG. 1, the report creation system 1 has a customer management device 10, a group management device 20, a device management device 30, devices 40-1 to 40-n (n≧1), a failure management device 50, a serviceman management device 60, a report creation device 70 and a user terminal 80. The customer management device 10, the group management device 20, the device management device 30, the devices 40-1 to 40-n (n≧1), the failure management device 50, the serviceman management device 60, the report creation device 70 and the user terminal 80 are connected through a network 2. The network 2 is realized by, for example, Internet or LAN (Local Area Network).

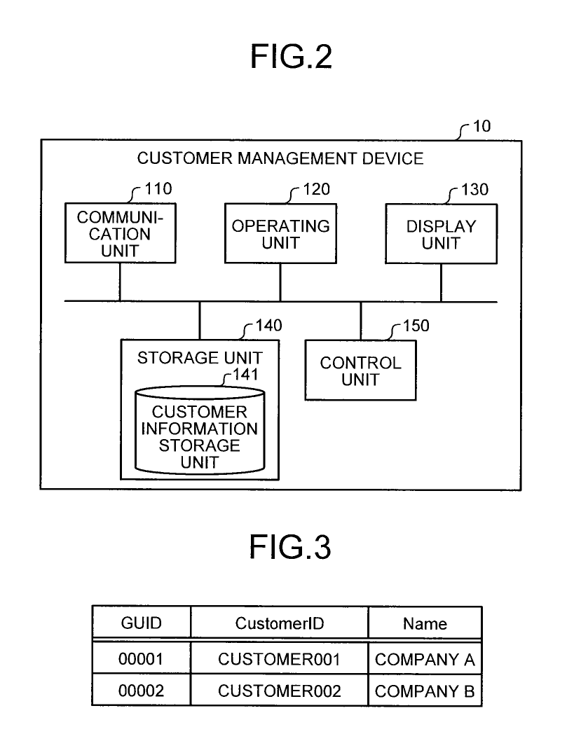

FIG. 2 is a block diagram illustrating an example of a configuration of the customer management device 10 according to the present embodiment. The customer management device 10 manages customer information, and, as illustrated in FIG. 2, has a communication unit 110, an operating unit 120, a display unit 130, a storage unit 140, and a control unit 150.

The communication unit 110 communicates with an external device such as the report creation device 70 through the network 2, and can be realized by a NIC (Network Interface Card).

The operating unit 120 inputs various operations, and can be realized by an input device such as a keyboard, a mouse, a touch pad and a touch panel.

The display unit 130 displays various screens, and can be realized by a display device such as a liquid crystal display and a touch panel display.

The storage unit 140 stores various programs executed by the customer management device 10 and data used for various processing performed by the customer management device 10. The storage unit 140 can be realized by at least one of storage devices which can magnetically, optically and electrically store data such as a HDD (Hard Disk Drive), a SSD (Solid State Drive), a memory card, an optical disk and a RAM (Random Access Memory). The storage unit 140 includes a customer information storage unit 141.

The customer information storage unit 141 stores customer information which is information about a customer. FIG. 3 is a view illustrating an example of customer information according to the present embodiment. In an example in FIG. 3, customer information is information which associates a GUID (Globally Unique Identifier), a CustomerID and a Name. The GUID is an identifier for identifying a customer information record (customer information column). The CustomerID (an example of customer identification information) is an identifier for identifying a customer. The Name is a name of a customer.

The control unit 150 (an example of a customer management unit) controls each unit of the customer management device 10, and can be realized by a control device such as a CPU (Central Processing Unit). The control unit 150 manages an input and an output of customer information stored in the customer information storage unit 141.

The control unit 150 receives an input of new customer information from, for example, an administrator of the customer management device 10 through the operating unit 120, and, when receiving an input of update information of existing customer information, updates customer information stored in the customer information storage unit 141. Further, when, for example, receiving an input of a Name from the report creation device 70 through the communication unit 110, the control unit 150 acquires a customer information record including this Name from customer information stored in the customer information storage unit 141, and returns the record to the report creation device 70. In addition, the customer information record acquired by the control unit 150 only needs to include at least a CustomerID associated with the Name.

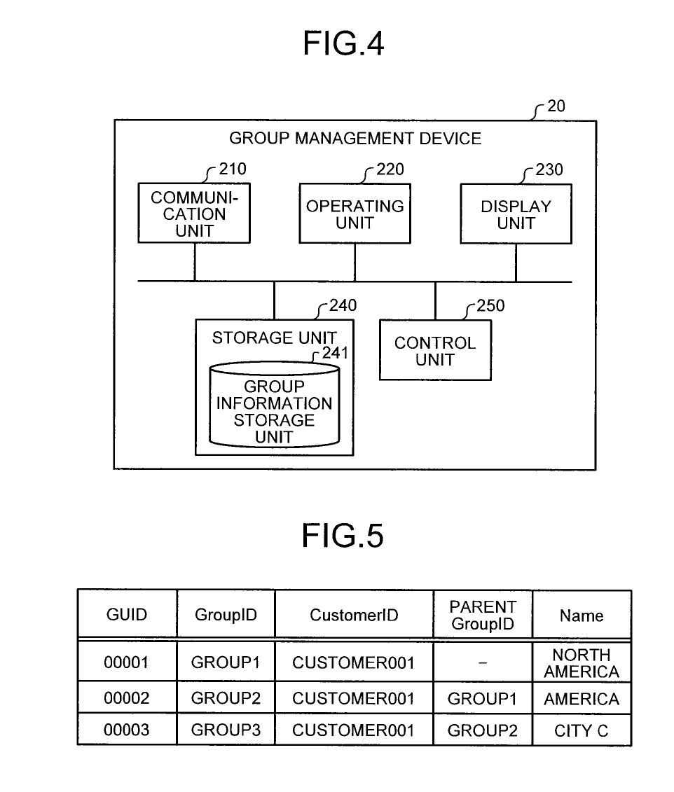

FIG. 4 is a block diagram illustrating an example of a configuration of the group management device 20 according to the present embodiment. The group management device 20 manages group information and, as illustrated in FIG. 4, has a communication unit 210, an operating unit 220, a display unit 230, a storage unit 240 and a control unit 250.

The communication unit 210 communicates with an external device such as the report creation device 70 through the network 2, and can be realized by the NIC.

The operating unit 220 inputs various operations, and can be realized by an input device such as a keyboard, a mouse, a touch pad and a touch panel.

The display unit 230 displays various screens, and can be realized by a display device such as a liquid crystal display and a touch panel display.

The storage unit 240 stores various programs executed by the group management device 20 and data used for various processing performed by the group management device 20. The storage unit 240 can be realized by at least one of storage devices which can magnetically, optically and electrically store data such as a HDD, a SSD, a memory card, an optical disk and a RAM. The storage unit 240 includes a group information storage unit 241.

The group information storage unit 241 stores group information which is information about a customer group. Although the customer group only needs to segmentalize customers so that each customer belongs to any group and corresponds to a customer region configuration or a customer organization configuration such as a continent, a country/area, or a city, the customer group is not limited to this. Further, the group may form a hierarchical structure.

FIG. 5 is a view illustrating an example of group information according to the present embodiment. In an example illustrated in FIG. 5, the group information is information which associates a GUID, a GroupID, a CustomerID, a parent GroupID and a Name. The GUID is an identifier for identifying a group information record (group information column). The GroupID (an example of group identification information) is an identifier for identifying a group. The CustomerID is an identifier for identifying a customer. The parent GroupID is an identifier for identifying an upper group. The Name is a name of a group.

In the examples illustrated in FIGS. 3 and 5, a group (region configuration) of company A of CustomerID “CUSTOMER001” adopts a hierarchical structure in which America of GroupID “GROUP2” belongs to North America of GroupID “GROUP1”, and city C of GroupID “GROUP3” belongs to America of GroupID “GROUP2”.

The control unit 250 (an example of a group management unit) controls each unit of the group management device 20, and can be realized by a control device such as a CPU. The control unit 250 manages an input and an output of group information stored in the group information storage unit 241.

When, for example, receiving an input of new group information or an input of update information of existing group information from, for example, an administrator of the group management device 20 through the operating unit 220, the control unit 250 updates group information stored in the group information storage unit 241. Further, when, for example, receiving an input of a CustomerID from the report creation device 70 through the communication unit 210, the control unit 250 acquires a group information record including the CustomerID from the group information stored in the group information storage unit 241, and returns the record to the report creation device 70. In addition, the group information record acquired by the control unit 250 only needs to include at least a GroupID associated with the CustomerID.

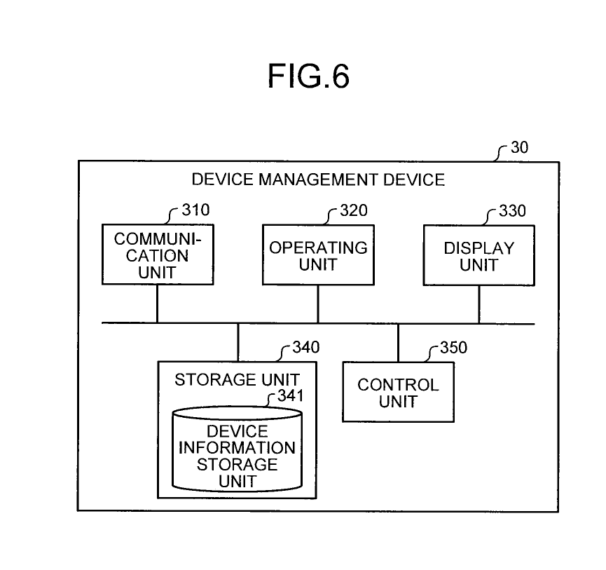

FIG. 6 is a block diagram illustrating an example of a configuration of the device management device 30 according to the present embodiment. The device management device 30 manages device information about the devices 40-1 to 40-n, and, as illustrated in FIG. 6, has a communication unit 310, an operating unit 320, a display unit 330, a storage unit 340 and a control unit 350.

The devices 40-1 to 40-n only needs to be devices which can connect to the network 2, and are, for example, an image forming device such as a printing device, a copying machine, a MFP (Multifunction Peripheral), a scanner device and a facsimile device, various electronic devices such as a projector, a camera, an air-conditioner, a refrigerator, a fluorescent lamp, a vending machine and a hand-held terminal, and an information processing device such as a PC. The MFP has at least two functions of a copying function, a printing function, a scanner function and a facsimile function. Although the devices 40-1 to 40-n are MFPs according to the present embodiment, the devices are not limited to these.

The communication unit 310 communicates with external devices such as the devices 40-1 to 40-n and the report creation device 70 through the network 2, and can be realized by the NIC.

The operating unit 320 inputs various operations, and can be realized by an input device such as a keyboard, a mouse, a touch pad and a touch panel.

The display unit 330 displays various screens, and can be realized by a display device such as a liquid crystal display and a touch panel display.

The storage unit 340 stores various programs executed by the device management device 30 and data used for various processing performed by the device management device 30. The storage unit 340 can be realized by at least one of storage devices which can magnetically, optically and electrically store data such as a HDD, a SSD, a memory card, an optical disk and a RAM. The storage unit 340 has a device information storage unit 341.

The device information storage unit 341 stores device information about the devices 40-1 to 40-n. In addition, device information may be any information as long as the device information is information about device management.

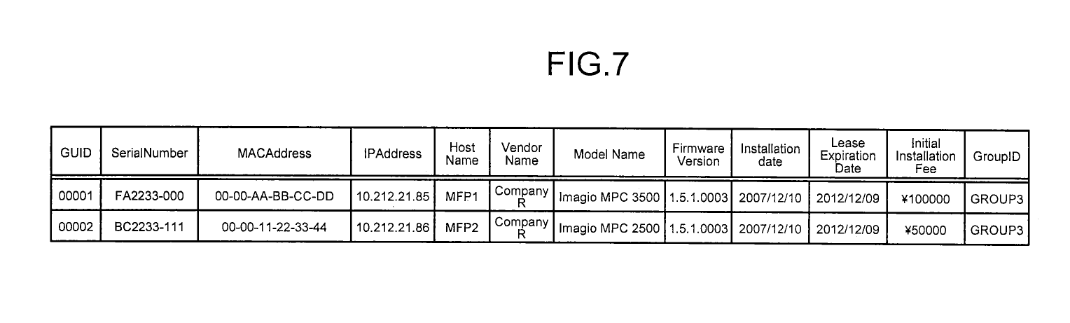

FIG. 7 is a view illustrating an example of device information according to the present embodiment. In an example illustrated in FIG. 7, device information is information which associates a GUID, a SerialNumber, a MACAddress, an IPAddress, a Host name, a Vendor name, a Model name, a FirmwareVersion, an installation date, a lease expiration date, an initial installation fee and a GroupID.

The GUID is an identifier for identifying a device information record (device information column). A SerialNumber (an example of device identification information) is an identifier for identifying a device. A device of the SerialNumber is included in a group of a GroupID described below (more specifically, a customer of a CustomerID associated with the GroupID in the group information illustrated in FIG. 5). The MACAddress is a MAC address of a device. The IPAddress is an IP address of a device. The Host name is a host name of a device. The Vendor name is a vendor name of a device. The Model name is a model name of a device. The FirmwareVersion is a version of firmware installed in a device. The installation date is a date on which a device is installed (introduced) in customer environment. The lease expiration date is a lease expiration date of a device to a customer. The initial installation fee is an initial fee required to install a device in customer environment. The GroupID is an identifier for identifying a group.

The control unit 350 (an example of a device management unit) controls each unit of the device management device 30, and can be realized by a control device such as a CPU. The control unit 350 manages an input and an output of device information stored in the device information storage unit 341.

For example, the control unit 350 acquires device information from the devices 40-1 to 40-n through the communication unit 310, stores the device information in the device information storage unit 341 when the device information is device information about a new device and updates the device information stored in the device information storage unit 341 when the device information is device information about an existing device. More specifically, the control unit 350 acquires device information by performing communication with the devices 40-1 to 40-n using a general protocol such as SNMP (Simple Network Management Protocol) which is generally used for device management. In addition, a method of acquiring device information may be a method of subjectively acquiring device information from the devices 40-1 to 40-n by the control unit 350 or a method of subjectively notifying device information from the devices 40-1 to 40-n to the device management device 30 (control unit 350).

Further, when, for example, receiving an input of a GroupID from the report creation device 70 through the communication unit 310, the control unit 350 acquires a device information record including this GroupID from device information stored in the device information storage unit 341, and returns the record to the report creation device 70. In addition, the device information record acquired by the control unit 350 only needs to include at least a SerialNumber associated with the GroupID.

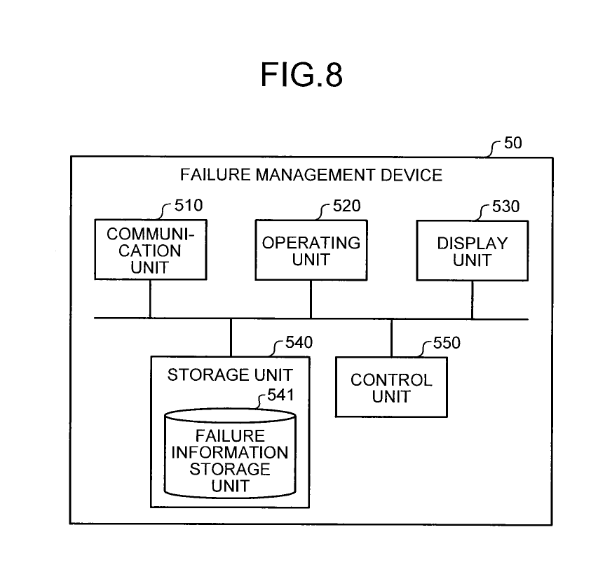

FIG. 8 is a block diagram illustrating an example of a configuration of the failure management device 50 according to the present embodiment. The failure management device 50 manages failure information (ticket) of failure which occurs in the devices 40-1 to 40-n, and, as illustrated in FIG. 8, has a communication unit 510, an operating unit 520, a display unit 530, a storage unit 540 and a control unit 550.

The communication unit 510 communicates with an external device such as the report creation device 70 through the network 2, and can be realized by the NIC.

The operating unit 520 inputs various operations, and can be realized by an input device such as a keyboard, a mouse, a touch pad and a touch panel.

The display unit 530 displays various screens, and can be realized by a display device such as a liquid crystal display and a touch panel display.

The storage unit 540 stores various programs executed by the failure management device 50 and data used for various processing performed by the failure management device 50. The storage unit 540 can be realized by at least one of storage devices which can magnetically, optically and electrically store data such as a HDD, a SSD, a memory card, an optical disk and a RAM. The storage unit 540 has a failure information storage unit 541.

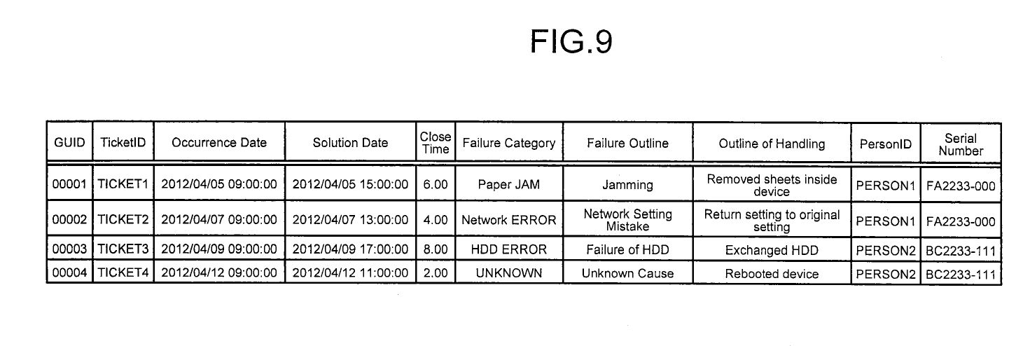

The failure information storage unit 541 stores failure information about failure which occurs in the devices 40-1 to 40-n. FIG. 9 is a view illustrating an example of failure information according to the present embodiment. In the example illustrated in FIG. 9, failure information is information which associates a GUID, a TicketID, an occurrence date, a solution date, a Close time, a failure category, a failure outline, a handling outline, a PersonID and a SerialNumber.

The GUID is an identifier for identifying a failure information record (failure information column). The TicketID (an example of failure identification information) is an identifier for identifying failure which occurs. The occurrence date is an occurrence date of failure. The solution date is a solution date of failure. The Close time is a time spent until failure is solved after the failure occurs, and a solution date—an occurrence date. The failure category is a category of failure content. The failure outline is an outline of failure content. The handling outline is an outline of handling content performed with respect to failure. The PersonID is an identifier for identifying a serviceman who handles failure. The SerialNumber is an identifier for identifying a device.

The control unit 550 (an example of a failure management unit) controls each unit of the failure management device 50, and can be realized by a control device such as a CPU. The control unit 550 manages an input and an output of failure information stored in the failure information storage unit 541.

When, for example, receiving an input of new failure information, issuing a ticket or receiving an input of update information of existing failure information from, for example, an administrator of the failure management device 50 through the operating unit 520, the control unit 550 updates failure information stored in the failure information storage unit 541. Further, when, for example, receiving an input of a SerialNumber from the report creation device 70 through the communication unit 510, the control unit 550 acquires a group information record including this SerialNumber from the failure information stored in the failure information storage unit 541, and returns the record to the report creation device 70. In addition, the group information record acquired by the control unit 550 only needs to include at least a PersonID associated with the SerialNumber.

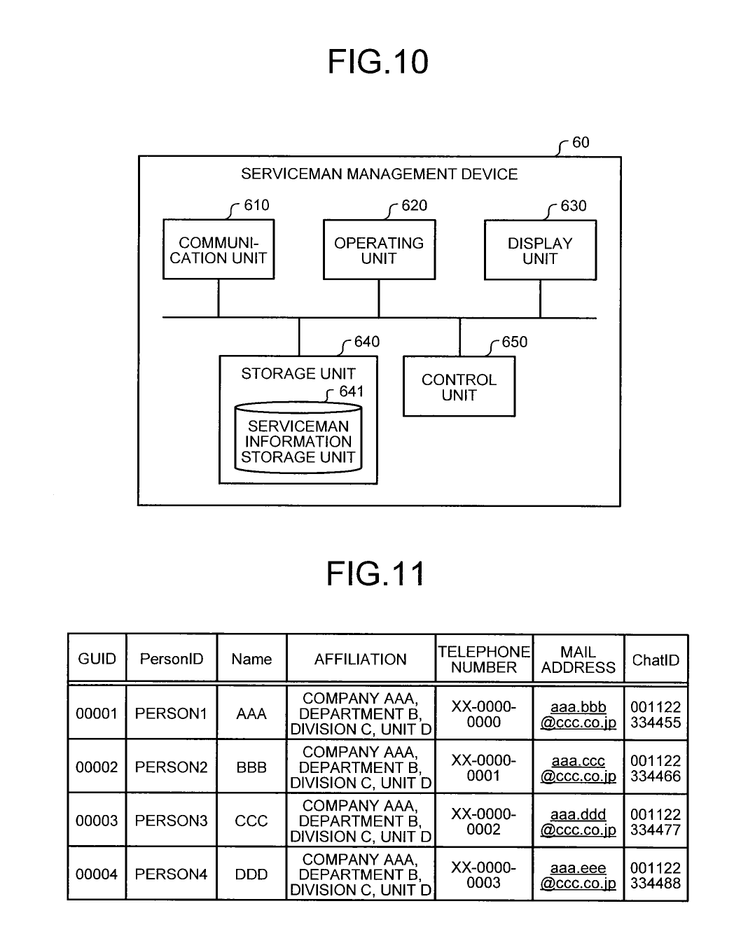

FIG. 10 is a block diagram illustrating an example of a configuration of the serviceman management device 60 according to the present embodiment. The serviceman management device 60 manages serviceman information (an example of person information), and, as illustrated in FIG. 10, has a communication unit 610, an operating unit 620, a display unit 630, a storage unit 640 and a control unit 650.

The communication unit 610 communicates with an external device such as the report creation device 70 through the network 2, and can be realized by the NIC.

The operating unit 620 inputs various operations, and can be realized by an input device such as a keyboard, a mouse, a touch pad and a touch panel.

The display unit 630 displays various screens, and can be realized by a display device such as a liquid crystal display and a touch panel display.

The storage unit 640 stores various programs executed by the serviceman management device 60 and data used for various processing performed by the serviceman management device 60. The storage unit 640 can be realized by at least one of storage devices which can magnetically, optically and electrically store data such as a HDD, a SSD, a memory card, an optical disk and a RAM. The storage unit 640 has a serviceman information storage unit 641.

The serviceman information storage unit 641 stores serviceman information which is information about a serviceman (an example of a person) which handles failure which occurs in the devices 40-1 to 40-n, and which indicates at least a contact number of the serviceman. FIG. 11 is a view illustrating an example of serviceman information according to the present embodiment. In an example illustrated in FIG. 11, serviceman information is information which associates a GUID, a PersonID, a Name, an affiliation, a telephone number, a mail address and a ChatID.

The GUID is an identifier for identifying a serviceman information record (serviceman information column). The Person ID (an example of person identification information) is an identifier for identifying a serviceman. The Name is a name of a serviceman. An affiliation is an organization which a serviceman is affiliated with. The telephone number is a telephone number of a service man, and a contact number. The mail address is a mail address of a serviceman, and a contact number. The ChatID is a chat ID of a serviceman, and a contact number.

The control unit 650 (an example of a person management unit) controls each unit of the serviceman management device 60, and can be realized by a control device such as a CPU. The control unit 650 manages an input and an output of serviceman information stored in the serviceman information storage unit 641.

When, for example, receiving an input of new serviceman information or an input of update information of existing serviceman information from, for example, an administrator of the serviceman management device 60 through the operating unit 620, the control unit 650 updates serviceman information stored in the serviceman information storage unit 641. Further, when, for example, receiving an input of a PersonID from the report creation device 70 through the communication unit 610, the control unit 650 acquires a group information record including the PersonID from the serviceman information stored in the serviceman information storage unit 641, and returns the record to the report creation device 70. In addition, the group information record acquired by the control unit 650 only needs to include at least a contact number associated with a PersonID, that is, at least one of a telephone number, a mail address and a chat ID. Although a contact number of a service man includes a telephone number, a mail address and a chat ID in the present embodiment, the contact number is not limited to this.

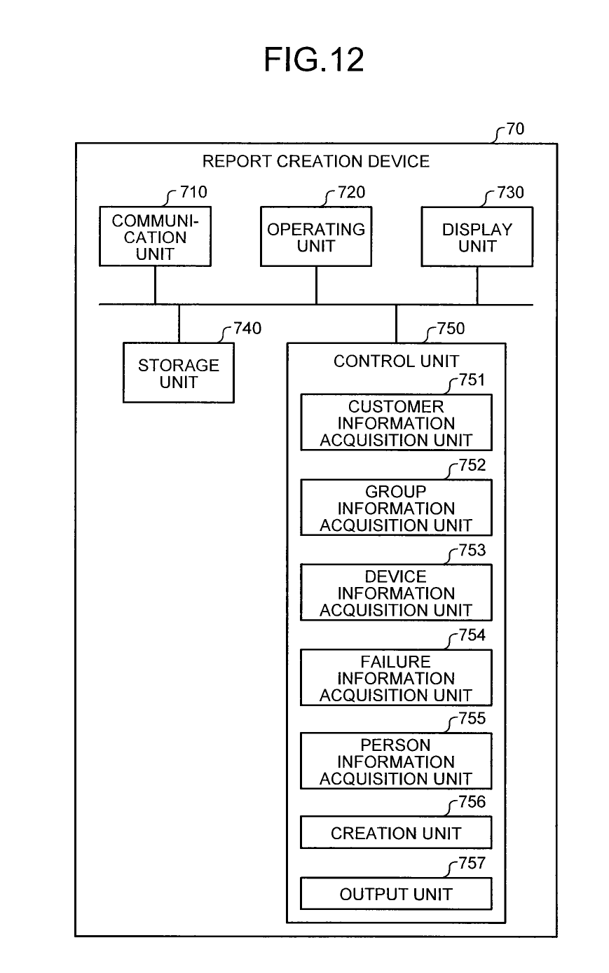

FIG. 12 is a block diagram illustrating an example of a configuration of the report creation device 70 according to the present embodiment. The report creation device 70 acquires customer information from the customer management device 10, group information from the group management device 20, device information from the device management device 30, failure information from the failure management device 50 and serviceman information from the serviceman management device 60 and creates a service report, and, as illustrated in FIG. 12, has a communication unit 710, an operating unit 720, a display unit 730, a storage unit 740 and a control unit 750.

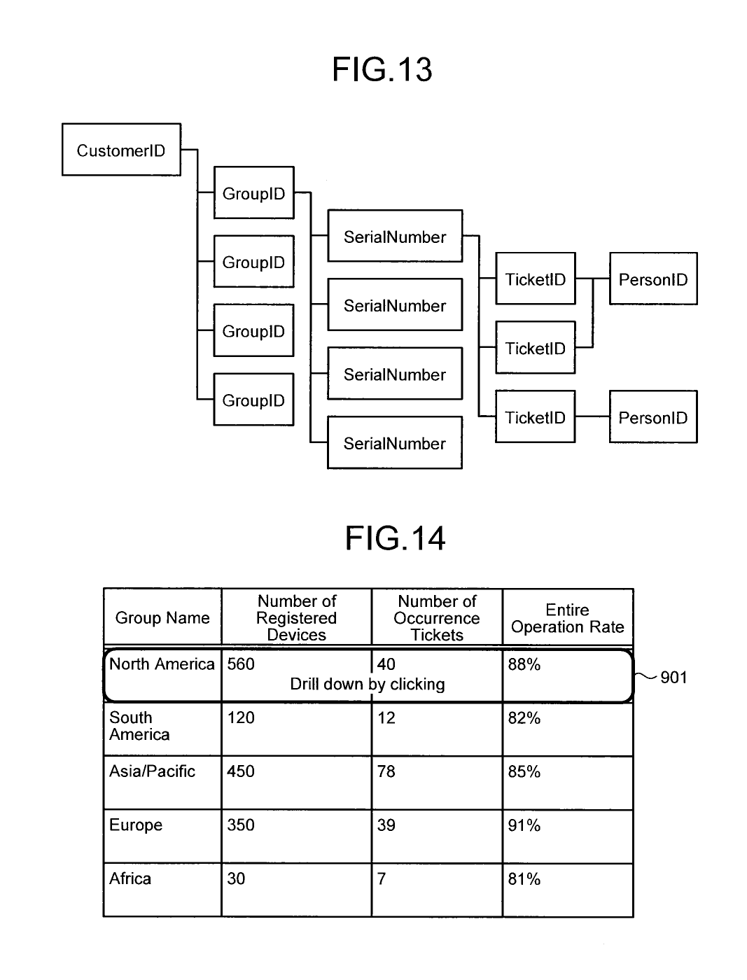

FIG. 13 is a view illustrating an example of a hierarchical structure of customer information, group information, device information, failure information and serviceman information according to the present embodiment, and illustrates a CustomerID as customer information, a GroupID as group information, a SerialNumber as device information, a TicketID as failure information and a PersonID as serviceman information.

As illustrated in FIG. 13, information used to create a service report adopts a hierarchical structure in which the GroupID belongs to the CustomerID, the SerialNumber belongs to the GroupID, the TicketID belongs to the SerialNumber and the PersonID belongs to the TicketID.

A communication unit 710 communicates with external devices such as the customer management device 10, the group management device 20, the device management device 30, the failure management device 50, the serviceman management device 60 and the user terminal 80 through the network 2, and can be realized by the NIC.

The operating unit 720 inputs various operations, and can be realized by an input device such as a keyboard, a mouse, a touch pad and a touch panel.

The display unit 730 displays various screens, and can be realized by a display device such as a liquid crystal display and a touch panel display.

The storage unit 740 stores various programs such as a report creation program executed by the report creation device 70 and data used for various processing performed by the report creation device 70. The storage unit 740 can be realized by at least one of storage devices which can magnetically, optically and electrically store data such as a HDD, a SSD, a memory card, an optical disk and a RAM.

The control unit 750 controls each unit of the report creation device 70, and can be realized by a control device such as a CPU. The control unit 750 has a customer information acquisition unit 751, a group information acquisition unit 752, a device information acquisition unit 753, a failure information acquisition unit 754, a person information acquisition unit 755, a creation unit 756 and an output unit 757. Meanwhile, by activating (executing) the report creation program stored in the storage unit 740, the control unit 750 realizes the customer information acquisition unit 751, the group information acquisition unit 752, the device information acquisition unit 753, the failure information acquisition unit 754, the person information acquisition unit 755, the creation unit 756 and the output unit 757 as software.

The customer information acquisition unit 751 acquires customer information. When, for example, receiving an input of a Name which is a customer name from the user terminal 80 through the communication unit 710, the customer information acquisition unit 751 transmits this Name to the customer management device 10 through the communication unit 710 and acquires a customer information record including this Name from the customer management device 10.

The group information acquisition unit 752 acquires group information. The group information acquisition unit 752 transmits, for example, a CustomerID included in the customer information record acquired by the customer information acquisition unit 751, to the group management device 20 through the communication unit 710, and acquires a group information record including this CustomerID from the group management device 20.

The device information acquisition unit 753 acquires device information. The device information acquisition unit 753 transmits, for example, a GroupID included in the group information record acquired by the group information acquisition unit 752, to the device management device 30 through the communication unit 710, and acquires a device information record including this GroupID from the device management device 30. By this means, the device information acquisition unit 753 acquires device information about a device which a group (more specifically, a customer) has.

The failure information acquisition unit 754 acquires failure information. The failure information acquisition unit 754 transmits, for example, a SerialNumber included in the device information record acquired by the device information acquisition unit 753, to the failure management device 50 through the communication unit 710, and acquires a failure information record including this SerialNumber from the failure management device 50. By this means, the failure information acquisition unit 754 acquires failure information about failure which occurs in a device which a group (more specifically, a customer) has.

The person information acquisition unit 755 acquires serviceman information. The person information acquisition unit 755 transmits, for example, a TicketID included in a failure information record acquired by the failure information acquisition unit 754, to the serviceman management device 60 through the communication unit 710, and acquires a serviceman information record including this TicketID from the serviceman management device 60. By this means, the person information acquisition unit 755 acquires serviceman information about a serviceman who handles failure which occurs in a device which a group (more specifically, a customer) has.

The creation unit 756 creates a report based on the device information acquired by the device information acquisition unit 753, the failure information acquired by the failure information acquisition unit 754 and the serviceman information acquired by the person information acquisition unit 755. More specifically, the creation unit 756 creates a report based on the customer information acquired by the customer information acquisition unit 751, the group information acquired by the group information acquisition unit 752, the device information acquired by the device information acquisition unit 753, the failure information acquired by the failure information acquisition unit 754 and the serviceman information acquired by the person information acquisition unit 755.

The creation unit 756 creates, for example, a report which adopts a hierarchical structure of a group report related to a group, a device report related to a device, a failure report related to failure and contact number information about a person. In addition, the creation unit 756 may create a group report which adopts a hierarchical structure of groups.

The output unit 757 outputs a report created by the creation unit 756. The output unit 757 outputs, for example, a report created by the creation unit 756, to the user terminal 80 through the communication unit 710.

The user terminal 80 sends a Name of a customer to the report creation device 70 on a browser displayed on the display device which is not illustrated, and requests, for example, creation of a report. Further, the user terminal 80 acquires a report created by the report creation device 70, and displays the acquired report on the browser.

FIGS. 14 to 19 are views illustrating examples of reports (report screens) according to the present embodiment, and the reports are created by the creation unit 756 and displayed by the user terminal 80.

FIG. 14 is a view illustrating an example of a group report in continent units according to the present embodiment. In an example illustrated in FIG. 14, the number of registered devices, the number of occurrence Tickets and the entire operation rate of each of North America, South America, Asia/Pacific, Europe and Africa are displayed as group reports in continent units of customers.

Meanwhile, the number of registered devices in North America is the total number of SerialNumbers associated with a GroupID of North America in device information acquired by the device information acquisition unit 753. In addition, when a group hierarchy adopts a structure in which America belongs to North America and city C belongs to America as described above, a SerialNumber associated with a GroupID of America and a GroupID of city C is a SerialNumber associated with the GroupID of North America.

Hence, even when a GroupID is not a GroupID of North America in the group information acquired by the group information acquisition unit 752, the creation unit 756 counts the total number of SerialNumbers by tracking a parent GroupID and also regarding a GroupID reaching the GroupID of North America as a GroupID of North America.

The number of occurrence Tickets of North America is the total number of TicketIDs associated with SerialNumbers used to calculate the number of registered Devices of North America in the failure information acquired by the failure information acquisition unit 754.

The entire operation rate of North America is calculated based on a total time of Close times associated with TicketIDs used to calculate the number of occurrence Tickets of North America in the failure information acquired by the failure information acquisition unit 754. For example, the entire operation rate of North America in one month is calculated according to ((the total operation time of one device in one month×the number of registered devices in North America)—the total time of Close times)/(the total operation time of one device in one month×the number of registered devices in North America)×100.

In addition, the number of registered Devices, the number of occurrence Tickets and the entire operation rate other than North America are calculated according to the same method as the above, and therefore will not be described in detail.

Further, in the example illustrated in FIG. 14, an operator of the user terminal 80 selects a record of a group report, so that a report drilled down to a lower layer is further displayed. Meanwhile, the operator of the user terminal 80 corresponds to a provider of a customer or a report (service), and is, for example, a responsible person of a customer company or a responsible person of a vendor company who is stationed at a customer company.

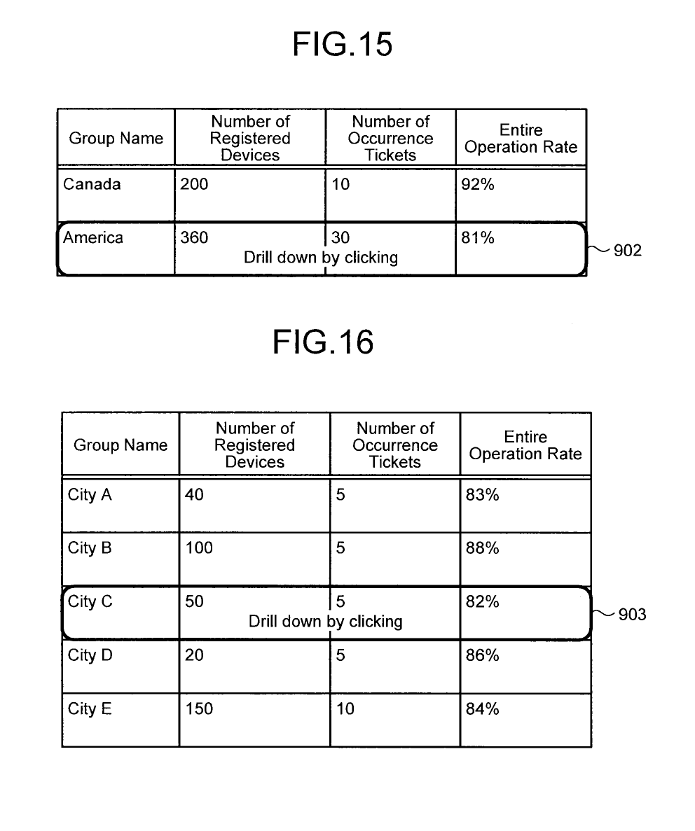

FIG. 15 is a view illustrating an example of a group report in country units according to the present embodiment, and the group report is displayed by clicking a record 901 of North America in the group report illustrated in FIG. 14. In an example illustrated in FIG. 15, the numbers of registered Devices, the numbers of occurrence Tickets and the entire operation rates of Canada and America are displayed as group reports in country units of customers.

In addition, the number of registered Devices, the number of occurrence Tickets and the entire operation rate are calculated according to the same method as in FIG. 14, and therefore will not be described in detail.

Further, in the example illustrated in FIG. 15, the operator of the user terminal 80 selects a record of a group report, so that a report drilled down to a lower layer is further displayed.

FIG. 16 is a view illustrating an example of a group report in city units according to the present embodiment, and the group report is displayed by clicking a record 902 of America in the group report illustrated in FIG. 15. In an example illustrated in FIG. 16, the numbers of registered Devices, the numbers of occurrence Tickets and the entire operation rates of city A to city E are displayed as group reports in city units of customers.

In addition, the number of registered Devices, the number of occurrence Tickets and the entire operation rate are calculated according to the same method as in FIG. 14, and therefore will not be described in detail.

Further, in the example illustrated in FIG. 16, the operator of the user terminal 80 selects a record of a group report, so that a report drilled down to a lower layer is further displayed.

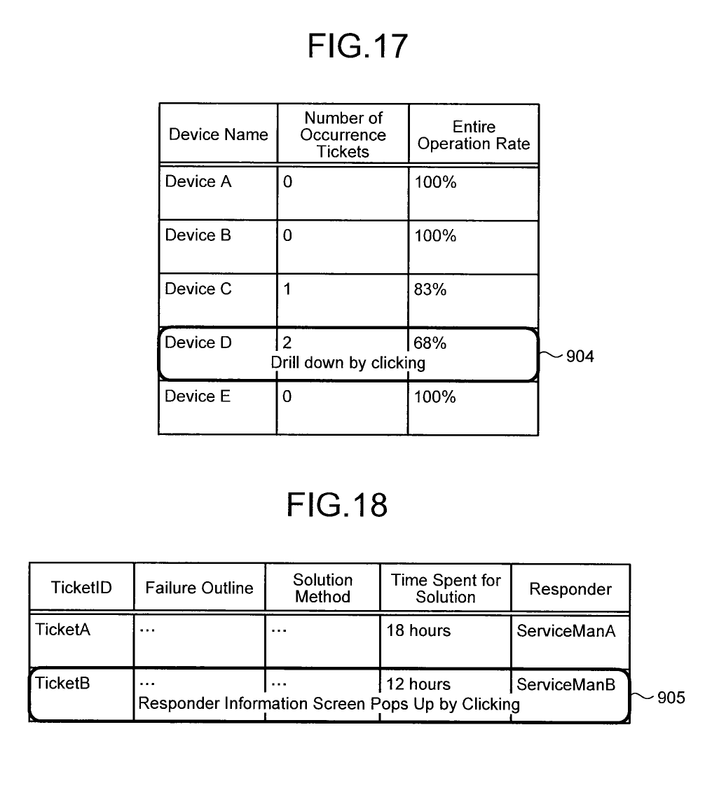

FIG. 17 is a view illustrating an example of a device report according to the present embodiment, and the device report is displayed by clicking a record 903 of city C in the group report illustrated in FIG. 16. In an example illustrated in FIG. 17, the numbers of occurrence Tickets and the operation rates of device A to device E are displayed as device reports of customers.

In addition, the number of occurrence Tickets and the entire operation rate are calculated according to the same method as in FIG. 14, and therefore will not be described in detail.

Further, in the example illustrated in FIG. 17, the operator of the user terminal 80 selects a record of a device report, so that a report drilled down to a lower layer is further displayed.

FIG. 18 is a view illustrating an example of a failure report according to the present embodiment, and the failure report is displayed by clicking a record 904 of the device D in the device report illustrated in FIG. 17. In an example illustrated in FIG. 18, failure outlines, solution methods, times spent for solution and responders of TicketA and TicketB are displayed as failure reports of customers.

In addition, a handling outline of failure information is displayed as a solution method, a Close time of failure information is displayed as the time spent for solution, and a Name associated with a PersonID of failure information in serviceman information is displayed as a responder.

Further, in the example illustrated in FIG. 18, the operator of the user terminal 80 selects a record of a failure report, so that contact number information about a person who handles the failure is further displayed.

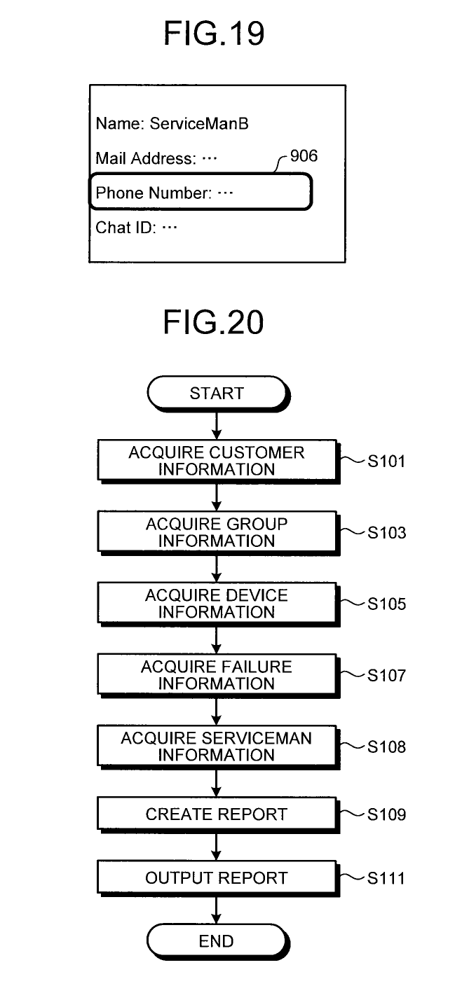

FIG. 19 is a view illustrating an example of contact number information according to the present embodiment, and contact number information is displayed by clicking a record 905 of TicketB in the failure report displayed in FIG. 18. In an example illustrated in FIG. 19, a Name of a serviceman, a Mail Address, a Phone Number and a ChatID are displayed as contact number information.

In an example illustrated in FIG. 19, the operator of the user terminal 80 selects the displayed telephone number, mail address or the ChatID to contact a serviceman displayed in the contact number information using the selected contact means.

Next, an operation of a report creation system according to the present embodiment will be described.

FIG. 20 is a flowchart illustrating an example of report creation processing executed by the report creation system 1 according to the present embodiment. In addition, processing illustrated in FIG. 20 may be executed at any operational timing, and is executed at this operational timing if, for example, a meeting is held on a regular basis between a customer and a provider of a report (service) and a contract to provide a service report to a customer is made.

When, for example, receiving an input of a Name which is a customer name from the user terminal 80 through the network 2, the customer information acquisition unit 751 of the report creation device 70 transmits this Name to the customer management device 10 through the network 2 and acquires a customer information record including this Name from the customer management device 10 (step S101).

Next, the group information acquisition unit 752 of the report creation device 70 transmits a CustomerID included in the customer information record acquired by the customer information acquisition unit 751, to the group management device 20 through the network 2, and acquires a group information record including this CustomerID from the group management device 20 (step S103).

Next, the device information acquisition unit 753 of the report creation device 70 transmits a GroupID included in the group information record acquired by the group information acquisition unit 752, to the device management device 30 through the network 2, and acquires a device information record including this GroupID from the device management device 30 (step S105).

Next, the failure information acquisition unit 754 of the report creation device 70 transmits a SerialNumber included in the device information record acquired by the device information acquisition unit 753, to the failure management device 50 through the network 2, and acquires a failure information record including this SerialNumber from the failure management device 50 (step S107).

Next, the person information acquisition unit 755 of the report creation device 70 transmits a TicketID included in a failure information record acquired by the failure information acquisition unit 754, to the serviceman management device 60 through the network 2, and acquires a serviceman information record including this TicketID from the serviceman management device 60 (step S108).

Next, the creation unit 756 of the report creation device 70 creates a report which adopts a hierarchical structure of a group report related to a group, a device report related to a device, a failure report related to failure and contact number information about a person based on the customer information acquired by the customer information acquisition unit 751, the group information acquired by the group information acquisition unit 752, the device information acquired by the device information acquisition unit 753, the failure information acquired by the failure information acquisition unit 754 and the serviceman information acquired by the person information acquisition unit 755 (step S109).

Next, the output unit 757 of the report creation device 70 outputs, for example, a report created by the creation unit 756, to the user terminal 80 through the network 2 (step S111).

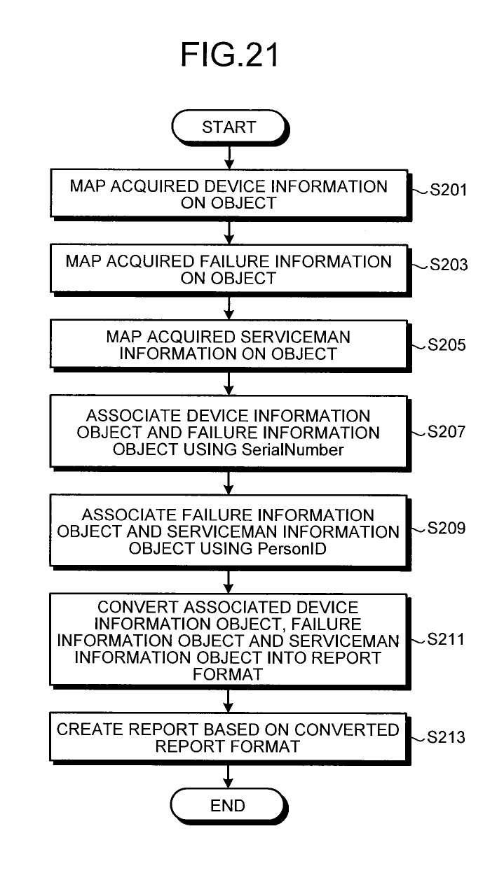

FIG. 21 is a flowchart illustrating an example of processing executed by the creation unit 756 according to the present embodiment.

First, the creation unit 756 maps the device information acquired by the device information acquisition unit 753 on an object, and generates a device information object (step S201).

Next, the creation unit 756 maps the failure information acquired by the failure information acquisition unit 754 on an object, and generates a failure information object (step S203).

Next, the creation unit 756 maps the serviceman information acquired by the person information acquisition unit 755 on an object, and generates a serviceman information object (step S205).

Next, the creation unit 756 associates the device information object and the failure information object using a SerialNumber included in the device information object and a SerialNumber included in the failure information object (step S207). By this means, data can be referred between the device information object and the failure information object.

Next, the creation unit 756 associates the failure information object and the serviceman information object using a PersonID included in the failure information object and a PersonID included in the serviceman information object (step S209). By this means, data can be referred between the failure information object and the serviceman information object.

Next, the creation unit 756 converts the associated device information object, failure information object and serviceman information object into a report format (step S211).

Next, the creation unit 756 creates a report according to the converted report format (step S213). More specifically, the creation unit 756 collects data according to the converted report format, and creates a report using a data collection result.

As described above, the report creation system 1 according to the present embodiment manages information about a serviceman who handles failure of a device and displays a contact number of this serviceman in a report, so that it is possible to contact this service man. Hence, according to the present embodiment, a user can analyze a report, make a call to a contact number of the serviceman related to a problem when the problem is found and conduct a hearing, so that it is possible to make the user take an action of solving the problem.

A report having a hierarchical structure and showing details of content by being drilled down to a lower layer is created according to the present embodiment in particular, so that, by drilling down a record of a report which seems to be a problem, it is possible to narrow down servicemen related to the problem and quickly solve the problem.

### MODIFICATION

In addition, the present invention is not limited to the above embodiment, and can be variously modified.

### Modification 1

Although an example has been described with the above embodiment where an administrator of a failure management device accumulates failure information (ticket) in a failure management device, synchronization with failure information from an external failure management device which has already started operating may be established.

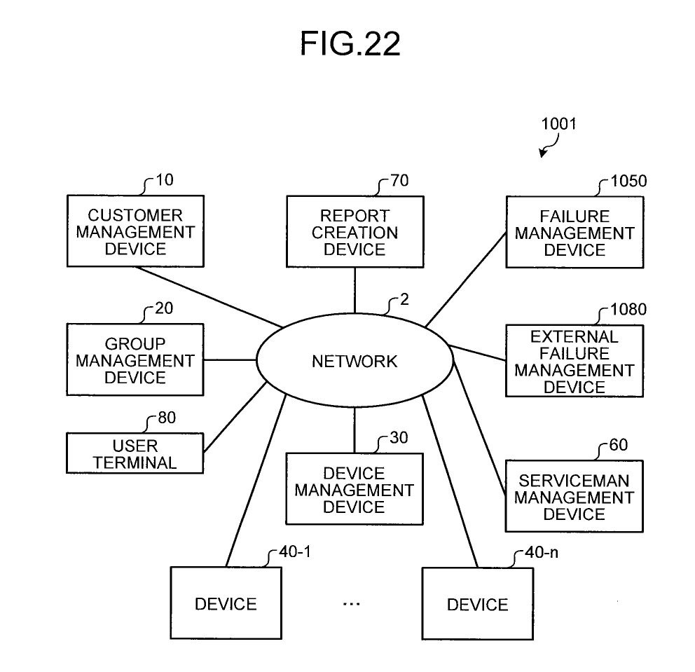

FIG. 22 is a block diagram illustrating an example of a configuration of a report creation system 1001 according to Modification 1. As illustrated in FIG. 22, the report creation system 1001 according to Modification 1 differs from the first embodiment in a failure management device 1050 and an external failure management device 1080.

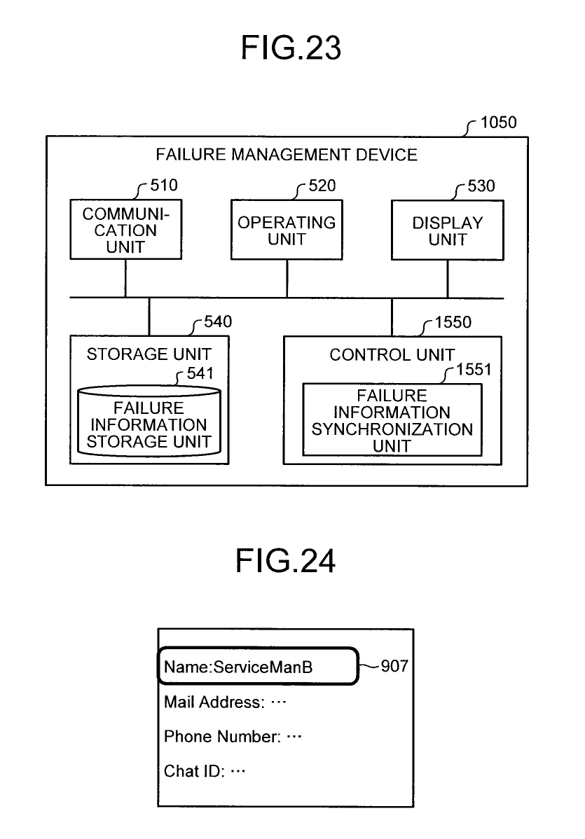

FIG. 23 is a block diagram illustrating an example of a configuration of the failure management device 1050 according to Modification 1. As illustrated in FIG. 23, the failure management device 1050 according to Modification 1 differs from the first embodiment in that a control unit 1550 includes a failure information synchronization unit 1551.

The failure information synchronization unit 1551 synchronizes failure information which is managed by the external failure management device 1080 (an example of an external device) and failure information managed by the failure information synchronization unit. More specifically, the failure information synchronization unit 1551 communicates with the external failure management device 1080 on a regular basis, acquires failure information managed by the external failure management device 1080 and overwrites failure information stored in a failure information storage unit 541.

According to Modification 1, it is possible to operate the report creation system by appropriating the external failure management device which has already started operating without additionally providing a failure management device.

### Modification 2

Although an example has been described with the above embodiment where a report adopting a hierarchical structure and showing details of content by being drilled down to a lower layer is created, a report may be drilled up to an upper layer.

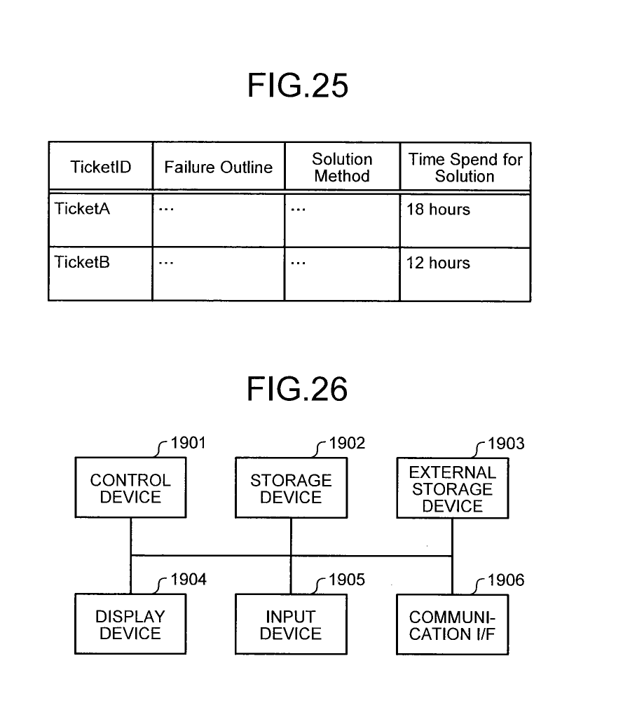

For example, an operator of a user terminal 80 may display a failure report of a failure record which a serviceman handles as illustrated in FIG. 25 by clicking a Name 907 of the displayed serviceman in contact number information illustrated in FIG. 24.

### Modification 3

In the above embodiment, the customer management device 10 manages content of a SLA (Service Level Agreement) contract in association with a customer. By so doing, it is possible to create a report which is further associated with content of the SLA contract. It is possible to create, for example, a report in which a record which does not satisfy the content of the SLA contract is marked. Further, a report may be drilled down by specializing in items which do not satisfy content of a SLA contract.

### Modification 4

Although an example has been described with the above embodiment where a customer management device 10, a group management device 20, a device management device 30, devices 40-1 to 40-n, a failure management device 50, a serviceman management device 60, a report creation device 70 and a user terminal 80 form a report creation system 1, the present invention is not limited to this, and a function of one of the devices may be substituted with another device. For example, the report creation device 70 has functions of the customer management device 10, the group management device 20, the device management device 30, the failure management device 50 and the serviceman management device 60 to form the report creation system 1.

### Modification 5

Although an example has been described with the above embodiment where a customer management device 10 stores customer information, a group management device 20 stores group information, a device management device 30 stores device information, a failure management device 50 stores failure information and a serviceman management device 60 stores serviceman information, at least one of these pieces of information may be stored outside (for example, on a cloud).

### Hardware Configuration

FIG. 26 is a view illustrating a hardware configuration of a customer management device 10, a group management device 20, a device management device 30, devices 40-1 to 40-n, a failure management device 50, a serviceman management device 60, a report creation device 70 and a user terminal 80 according to the present embodiment and modifications (referred to “each device according to the present embodiment and modifications” below). Each device according to the present embodiment and modifications has a control device 1901 such as a CPU, a storage device 1902 such as a ROM and a RAM, an external storage device 1903 such as a HDD, a display device 1904 such as a display, an input device 1905 such as a keyboard or a mouse, and a communication I/F (interface) 1906, and employs a hardware configuration using a common computer.

A program executed by each device according to the present embodiment and modifications is stored in a computer-readable storage medium such as a CD-ROM, a CD-R, a memory card, a DVD (Digital Versatile Disk) or a flexible disk (FD) of an installable format or an executable format, and is provided.

Further, each device according to the embodiment and modifications may be provided by being stored on a computer connected to a network such as Internet, and being downloaded through a network. Furthermore, the program executed by each device according to the embodiment and modifications may be provided or distributed through a network such as Internet. Still further, the program executed by each device according to the embodiment and modifications may be implemented in, for example, a ROM in advance and provided.

The program executed by each device according to the embodiment and modifications employs a module configuration for implementing each of the above units on the computer. The CPU as actual hardware reads a program from the HDD onto the RAM and executes the program, so that each of the above units is realized on the computer.

According to the embodiments, it is possible to provide an effect of creating a report which enables a user to take an action of solving a problem.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A report creation device comprising:
a device information acquisition unit configured to acquire device information about a device;
a failure information acquisition unit configured to acquire failure information about failure that occurs in the device;
a person information acquisition unit configured to acquire person information about a person who handles the failure that occurs in the device, the person information indicating at least a contact number of the person;
a creation unit configured to create a report based on the device information, the failure information, and the person information; and
an output unit configured to output the report.

2. The report creation device according to claim 1, further comprising a customer information acquisition unit configured to acquire customer information about a customer, wherein
the device information acquisition unit is configured to acquire device information about a device that the customer has, and
the creation unit is configured to create the report based on the customer information, the device information, the failure information, and the person information.

3. The report creation device according to claim 2, further comprising a group information acquisition unit configured to acquire group information about a group to which the customer belongs, wherein
the device information acquisition unit is configured to acquire device information about a device which the group has, and
the creation unit is configured to create the report based on the customer information, the group information, the device information, the failure information, and the person information.

4. The report creation device according to claim 3, wherein
the customer information includes at least customer identification information for identifying the customer,
the group information includes at least group identification information for identifying the group and the customer identification information,
the group information acquisition unit is configured to acquire, as the group information, group information that includes customer identification information matching the customer identification information included in the customer information acquired by the customer information acquisition unit,
the device information includes at least device identification information for identifying the device and the group identification information,
the device information acquisition unit is configured to acquire, as the device information, device information that includes group identification information matching the group identification information included in the group information acquired by the group information acquisition unit,
the failure information includes at least failure identification information for identifying the failure and the device identification information,
the failure information acquisition unit is configured to acquire, as the failure information, failure information that includes device identification information matching the device identification information included in the device information acquired by the device information acquisition unit,
the person information includes at least the failure identification information, and
the person information acquisition unit is configured to acquire, as the person information, person information that includes failure identification information matching the failure identification information included in the failure information acquired by the failure information acquisition unit.

5. The report creation device according to claim 3, wherein the creation unit is configured to create a report having a hierarchical structure of a group report about the group, a device report about the device, a failure report about the failure, and contact number information about the person.

6. The report creation device according to claim 5, wherein
the group has a hierarchical structure, and
the creation unit is configured to create the group report according to the hierarchical structure of the group.

7. A report creation system comprising:
a device management unit configured to manage device information about a device;
a failure management unit configured to manage failure information about failure that occurs in the device;
a person management unit configured to manage person information about a person who handles the failure that occurs in the device, and which indicates at least a contact number of the person;
a creation unit configured to create a report based on the device information, the failure information, and the person information; and
an output unit configured to output the report.

8. The report creation system according to claim 7, further comprising a customer management unit configured to manage customer information about a customer, wherein
the device management unit is configured to manage device information about a device that the customer has, and
the creation unit is configured to create a report based on the customer information, the device information, the failure information, and the person information.

9. The report creation system according to claim 8, further comprising a group management unit configured to manage group information about a group to which the customer belongs, wherein
the device management unit is configured to manage device information about a device that the group has, and
the creation unit is configured to create a report based on the customer information, the group information, the device information, the failure information, and the person information.

10. The report creation system according to claim 9, wherein
the customer information includes at least customer identification information for identifying the customer,
the group information includes at least group identification information for identifying the group and the customer identification information,
the group information acquisition unit is configured to acquire, as the group information, group information that includes customer identification information matching the customer identification information included in the customer information acquired by the customer information acquisition unit,
the device information includes at least device identification information for identifying the device and the group identification information,
the device information acquisition unit is configured to acquire, as the device information, device information that includes group identification information matching the group identification information included in the group information acquired by the group information acquisition unit,
the failure information includes at least failure identification information for identifying the failure and the device identification information,
the failure information acquisition unit is configured to acquire, as the failure information, failure information that includes device identification information matching the device identification information included in the device information acquired by the device information acquisition unit,
the person information includes at least the failure identification information, and
the person information acquisition unit is configured to acquire, as the person information, person information that includes failure identification information matching the failure identification information included in the failure information acquired by the failure information acquisition unit.

11. The report creation system according to claim 9, wherein the creation unit is configured to create a report having a hierarchical structure of a group report about the group, a device report about the device, a failure report about the failure, and contact number information about the person.

12. The report creation system according to claim 11, wherein
the group has a hierarchical structure, and
the creation unit is configured to create the group report according to the hierarchical structure of the group.

13. The report creation system according to claim 7, wherein the failure management unit is configured to synchronize failure information managed by an external device and the failure information managed by the failure management unit.

14. A non-transitory computer-readable storage medium with an executable program stored thereon and executed by a computer, wherein the program instructs the computer to perform:
acquiring device information about a device;
acquiring failure information about failure that occurs in the device;
acquiring person information about a person who handles the failure that occurs in the device, the person information indicating at least a contact number of the person;
creating a report based on the device information, the failure information, and the person information; and
outputting the report.
